(19) United States
(12) Patent Application Publication
(10) Pub. No.: US 2026/0084610 A1
(43) Pub. Date: Mar. 26, 2026

(54) TRUCK BED STORAGE SYSTEM AND COMPONENTS

(71) Applicant: Revery 4x4 LLC, Lewiston, ID (US)

(72) Inventor: Justin Ruegsegger, Lewiston, ID (US)

(21) Appl. No.: 19/338,669

(22) Filed: Sep. 24, 2025

Related U.S. Application Data
(60) Provisional application No. 63/698,865, filed on Sep. 25, 2024.

(51) Int. Cl. B60P 7/08

(52) U.S. Cl. CPC B60P 7/0815

(57) ABSTRACT

A truck bed storage system and components includes an extruded rail capable of receiving one or more T-nuts having a rhomboid shape therein, a tie-down with a threaded fastener designed to be received by and engage with the T-nut, an access door configured to provide access to cargo stored within the truck bed, and a panel system configured to interface with the extruded rail to form a platform in a bed of the truck.

### CROSS-REFERENCE TO RELATED APPLICATIONS

This application claims priority to U.S. Provisional Application No. 63/698,865, titled “TRUCK BED STORAGE SYSTEM AND COMPONENTS”, filed Sep. 25, 2024, which is hereby incorporated by reference in its entirety.

### BACKGROUND

For as long as cargo has been out into truck beds, there has been a need to secure cargo within truck beds by using ropes, straps, and other suitable tie-downs in combination with one or more anchor points within the truck bed. As time has gone by, the sizes and shapes of cargo have varied and so have the sizes and shapes of truck beds. In order for truck beds of various sizes and shapes (e.g., long beds, short beds, step-side beds, fleet-side beds, etc.) to be able to secure various cargo loads (e.g., small loads, large loads, wide loads, narrow loads, and oddly shaped loads, etc.) truck beds must allow for various anchor points.

In order to provide a variety of potential anchor points, some truck beds include multiple permanently attached anchor points dispersed throughout the interior of the bed sides of the truck bed, while some truck beds provide internal rail systems along the inside surfaces of the bedsides of a truck bed that may provide adjustable anchor points. These solutions, however, are not ideal and do not allow for optimal versatility for securing cargo within a truck bed. In order to provide the ability for anchor points to be relocated throughout a truck bed within a first truck and a second truck bed that is different than the first truck bed, a new truck bed storage system is required with new truck bed system components.

Current solutions demonstrate particular shortcomings in real-world applications. For instance, permanently attached anchor points limit users to fixed locations that may not align with the specific dimensions or shape of their cargo, forcing suboptimal tie-down angles that can compromise load security. Similarly, existing rail systems often require specialized tools for installation and adjustment, making it difficult for users to quickly reposition anchor points when loading different types of cargo. Additionally, many current systems are designed for specific truck bed configurations, meaning that components cannot be transferred between different vehicles or adapted to various bed sizes without purchasing entirely new systems.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a cross-sectional side view of an extruded rail, according to at least one example.

FIG. 2 illustrates a front-top-side left perspective view of an extruded rail, according to at least one example.

FIG. 3 illustrates a front-top-side right perspective view of an extruded rail, according to at least one example.

FIG. 4 illustrates a cross-section side view of an extruded rail, according to at least one example.

FIG. 5 illustrates a top view of a T-nut, according to an embodiment of this disclosure.

FIG. 6 illustrates a top-side perspective view of a T-nut, according to an embodiment of this disclosure.

FIGS. 7A-7B depict a top view and side view of a T-nut, according to an embodiment of this disclosure.

FIG. 8 illustrates a top-side perspective view of a T-nut, according to an embodiment of this disclosure.

FIGS. 9A-9B illustrates a bottom-side perspective view of a T-nut, according to an embodiment of this disclosure.

FIGS. 10A-10C depict tie-down components in assembled and un-assembled configurations, according to an embodiment of this disclosure.

FIG. 11 illustrates a tie-down assembled in an extruded rail.

FIG. 12 illustrates a front perspective view of a tie-down assembled with the T-nut in an extruded rail, according to an embodiment of this disclosure.

FIGS. 13A-13B depict the truck bed storage system and components assembled within a truck, according to an embodiment of this disclosure.

FIG. 14 illustrates a closed access door within the truck bed storage system, according to an embodiment of this disclosure.

FIG. 15 illustrates a removed access door within the truck be storage system, according to an embodiment of this disclosure.

### DETAILED DESCRIPTION

The systems and devices described herein relate to a universal rail mounting system for a truck bed and components which may be capable of being secured in a plurality of different rail systems. In various embodiments, the mounting system includes an extruded rail configured to receive one or more T-nuts having a rhomboidal shape. A tie-down element having a threaded fastener is designed to be received by and engage with the T-nut to provide secure attachment to the rail. The system may further include an access door configured to provide entry to cargo stored within the truck bed, and a panel system configured to interface with the extruded rail to form a platform disposed within the bed of the truck.

The components of the truck bed storage system may be arranged to provide modular storage, tie-down, and cargo-management capabilities. The extruded rail can support multiple accessories and configurations, while the panel system can be adapted to define storage areas, elevated platforms, or subdivided compartments. Together, the rail, T-nuts, tie-downs, access door, and panel system cooperate to provide a secure, adaptable, and integrated solution for managing cargo within a truck bed.

The present disclosure relates to the field of vehicle cargo management systems, specifically focusing on truck bed storage and securing solutions that provide versatile anchor point configurations for various cargo types and truck bed designs.

Current truck bed cargo securing systems face significant limitations in providing optimal versatility and compatibility across different vehicle configurations. Permanently attached anchor points restrict users to fixed locations that may not align with specific cargo dimensions or shapes, forcing suboptimal tie-down angles that can compromise load security. Existing rail systems often require specialized tools for installation and adjustment, making it difficult for users to quickly reposition anchor points when loading different types of cargo. Additionally, many current systems are designed for specific truck bed configurations, meaning that components cannot be transferred between different vehicles or adapted to various bed sizes without purchasing entirely new systems.

The present invention addresses these challenges through a universal rail mounting system that incorporates a specialized T-nut with a rhomboid shape that enables toolless installation and repositioning of tie-down anchors. The extruded rail design accommodates T-nuts that can be inserted and rotated to a locked position without requiring additional tools, while the rhomboid geometry of the T-nut creates secure engagement with the rail's interior surfaces through angled portions that prevent rotation under load. This configuration allows users to quickly and easily reposition anchor points along the rail system to accommodate various cargo configurations while maintaining structural integrity and load-bearing capacity.

Furthermore, the invention incorporates a modular panel system that interfaces with the extruded rail to create elevated storage platforms with concealed storage cavities beneath, along with an integrated access door system that provides secure entry to these storage areas. The rail system's compatibility with both side and floor mounting configurations, combined with outward protrusions that enable flush installation with existing surfaces, creates a seamless integration that allows cargo to slide across without interference while maintaining the structural benefits of the rail system.

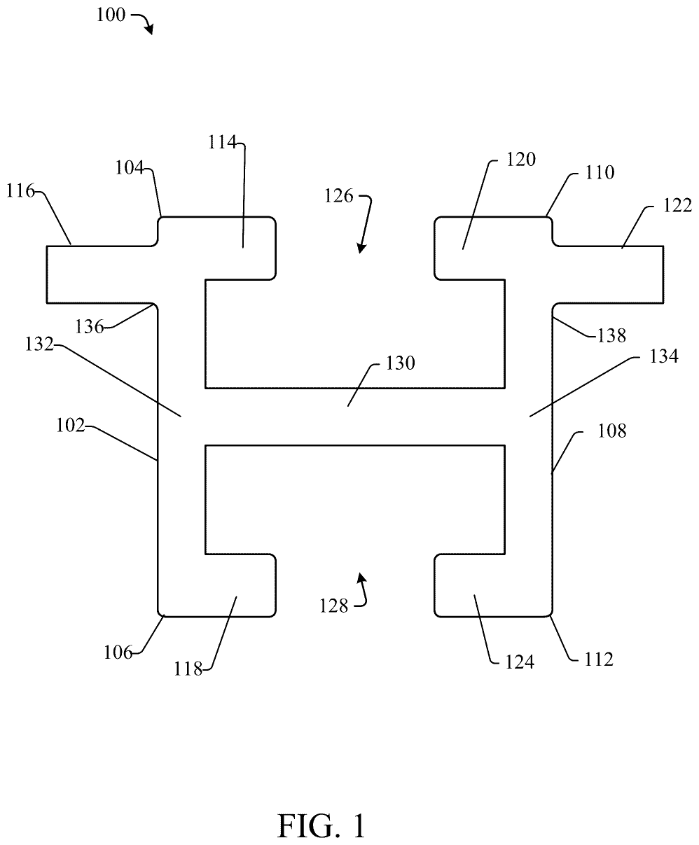

FIG. 1 illustrates a cross-sectional side view of an extruded rail profile (“rail 100”), according to at least one example. The rail 100 may include a first side wall 102 with a first top end 104 and a first bottom end 106 and a second side wall 108 with a second top end 110 and a second bottom end 112. The first side wall 102 and second side wall 108 are spaced apart from each other such as to create a space between them. A first inward protrusion 114 positioned at the first top end 104 of the first side wall 102 may extend towards the second side wall 108. A third inward protrusion 120 positioned at the second top end 110 of the second side wall 108 may extend towards the first side wall 102. The first inward protrusion 114 and the third inward protrusion 120 extend to create a first gap 126 between them. In various embodiments, the extruded rail 100 may be configured as either a side rail or a floor rail depending on the specific installation requirements within the truck bed. When configured as a side rail, the extruded rail 100 may be mounted along the interior sidewalls of the truck bed, providing anchor points for tie-downs that secure cargo laterally. When configured as a floor rail, the extruded rail 100 may be positioned along or across the truck bed floor, offering anchor points for securing cargo vertically or preventing forward and rearward movement during transport. The universal design of the extruded rail 100 allows the same rail profile to function effectively in either configuration without modification.

A second inward protrusion 118 positioned at the first bottom end 106 of the first side wall 102 may extend toward the second side wall 108. A fourth inward protrusion 124 positioned at the second bottom end 112 of the second side wall 108 may extend toward the first side wall 102. The second inward protrusion 118 and fourth inward protrusion 124 extend to create a second gap 128 between them. A cross member 130 may extend from a first position 132 of the first side wall 102 to a second position 134 of the second side wall 108. In non-limiting examples, the first position 132 may be disposed between the first top end 104 and the first bottom end 106 of the first side wall 102 and the second position 134 may be disposed between the second top end 110 and second bottom end 112 of the second side wall 108.

In certain non-limiting embodiments, the rail 100 may be formed from a variety of metals suitable for extrusion, machining, or other manufacturing processes. While the rail 100 can be produced from numerous materials, it is advantageous to construct the rail 100 from a hard aluminum alloy (e.g., such as a 7XXX series alloy) due to its strength-to-weight ratio, corrosion resistance, and ease of fabrication. Non-limiting examples include 6061-T6 aluminum, which may provide excellent structural integrity and weldability, and 7075 aluminum, for example including 7075-T6 aluminum, which may offer higher tensile strength and hardness for application requiring greater load-bearing capacity. Other metals and allows may be used to for the rail 100 depending on the desired performance characteristics. For example, steels, stainless steels, titanium allows, or other high-strength metals may be employed where increased toughness or specific environmental resistance is needed.

In non-limiting embodiments, the rail 100 and other components may be formed from strong non-metallic materials. For example, fiber-reinforced polymer composites, such as carbon fiber or glass fiber reinforced plastics, may be employed to reduce weight while maintaining structural rigidity. High-performance engineering plastics, including reinforced nylons or polyetheretherketone (PEEK), may also be utilized to provide strength, impact resistance, and resistance to environmental degradation.

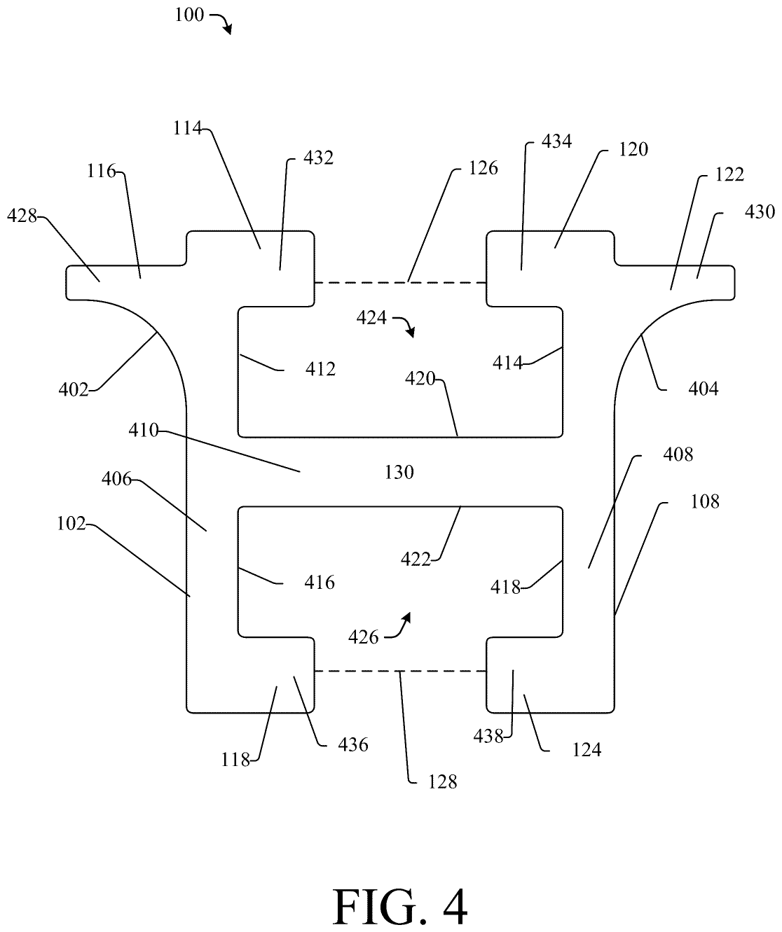

In non-limiting embodiments, the first side wal1 102 may include a first outward protrusion 116 that extends outward from the first top end 104 of the first side wall 102. Additionally, the second side wall 108 may include a second outward protrusion 122 that extends outward from the second top end 110 of the second side wall 108. The interface between the first and second side walls 102, 108 and the first and second outward protrusions 116, 122, respectively, may define a substantially right angle 136 and 138, thereby forming a distinct ledge projecting laterally from the first and second side walls 102, 108. In other non-limiting embodiments, the angles 136 and 138 may be defined by a sloped or curved surface, creating more of a gradual change in geometry (discussed more below in FIG. 4). The angle formed between the first and second side walls 102, 108 and the first and second outward protrusions 116, 122, respectively, may vary to accommodate strength, load distribution, or aesthetic considerations. For example, a right-angled interface may be used to maximize support for a panel or rail component, whereas a sloped or curved interface may be employed to reduce stress concentrations or to facilitate manufacturing processes.

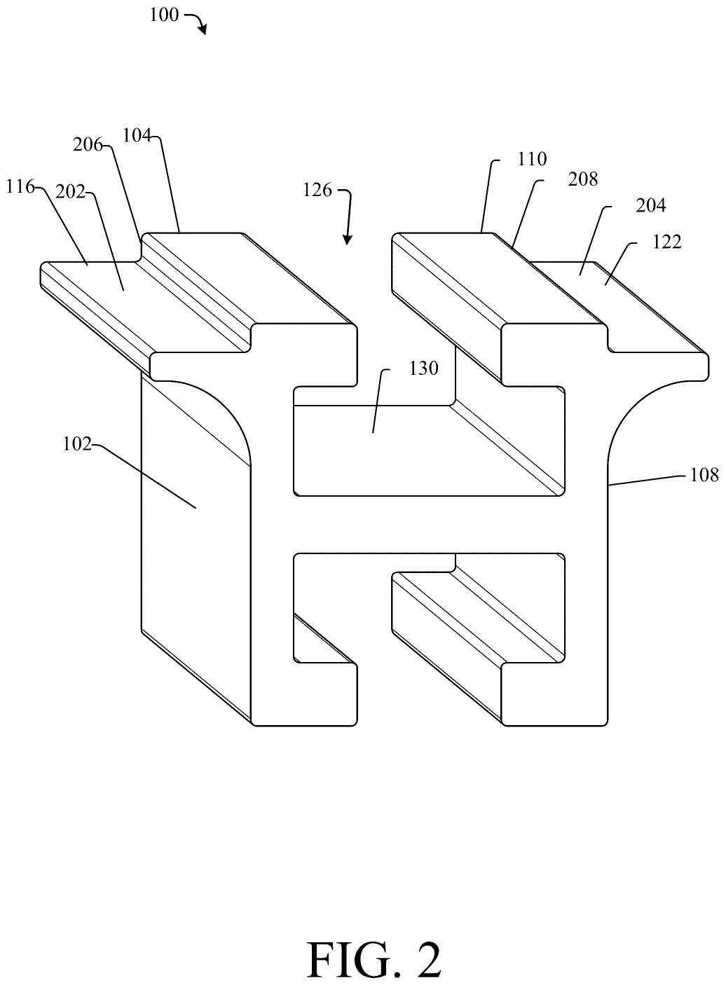

FIG. 2 illustrates a front-top-side left perspective view of an extruded rail, according to at least one example. In non-limiting examples, the first outward protrusion 116 may extend outwardly from the first side wall 102 at a position offset from the first top end 104. In such configurations, an upper surface 202 of the first outward protrusion 116 is located below the first top end 104 of the first side wall 102, defining a first edge 206 therebetween. The offset may create a step-down feature, such that the first top end 104 of the first side wall 102 projects above the first outward protrusion 116 and provides a raised boundary relative to the upper surface 202.

The second outward protrusion 122 may extend outwardly from the second side wall 108 at a position offset from the second top end 110. In such configurations, an upper surface 204 of the second outward protrusion 122 is located below the second top end 110 of the second side wall 108, defining a second edge 208 therebetween. The offset may create a step-down feature, such that the second top end 110 of the second side wall 108 projects above the second outward protrusion 122 and provides a raised boundary relative to the upper surface 204.

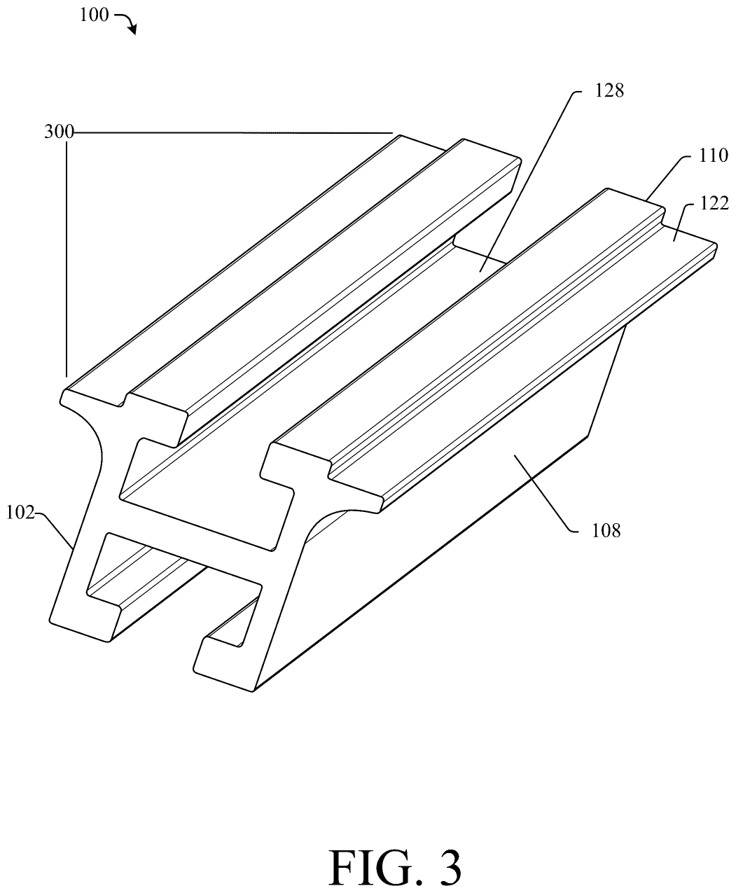

FIG. 3 illustrates a front-top-side right perspective view of an extruded rail, according to at least one example. FIG. 3 provides a complementary perspective to FIG. 2, showing the extruded rail 100 from the opposite side to illustrate the symmetrical nature of the rail design. From this front-top-side right perspective view, the second side wall 108 and its associated features are prominently displayed in the foreground, while the first side wall 102 and its corresponding elements are visible in the background. This view may clearly show the second outward protrusion 122 extending laterally from the second side wall 108, with its upper surface 204 positioned below the second top end 110 to create the second edge 208. The third inward protrusion 120 at the second top end 110 of the second side wall 108 may be visible extending toward the first side wall 102, contributing to the formation of the first gap 126. Similarly, the fourth inward protrusion 124 at the second bottom end 112 may be observed extending inward to help define the second gap 128. The cross-member 130 may be seen spanning between the first and second side walls 102, 108, providing structural continuity across the rail profile. This perspective view may also illustrate how the symmetrical design of the extruded rail 100 ensures consistent performance characteristics regardless of the orientation or mounting configuration, supporting the universal applicability of the rail system across different truck bed installations.

FIG. 4 illustrates a cross-section side view of an extruded rail, according to at least one example. As mentioned briefly above, in non-limiting embodiments, the interface between the first and second side walls 102, 108 and the first and second outward protrusions 116, 122 may define angles 402 and 404. In some embodiments, the angles 402 and 404 are substantially right angles. In other embodiments, such as the one depicted in FIG. 4, the angles 402 and 404 may define a sloped or curved surface, creating a more gradual change in geometry.

The first side wall 102 may have a thickness 406 and the second side wall 108 may have a thickness 408. The first side wall thickness 406 and the second side wall thickness 408 may be substantially the same, thereby providing a uniform profile across the structure. For example, one wall may be formed with a greater thickness to increase strength, rigidity, or load-bearing capacity, while another wall may be formed with a reduced thickness to minimize weight or material usage. The selection of the side wall thicknesses 406 and 408 may therefore be tailored to the intended function of the system and may vary along the length or height of the wall itself. In some configurations, the side wall thicknesses 406 and 408 may remain constant throughout the length of the rail 100, whereas in other configurations the thicknesses 406 and 408 may taper or otherwise change dimensionally to address structural, manufacturing, or aesthetic considerations.

The cross-member 130 which extends between the first side wall 102 and the second side wall 108 may have a thickness 410. In non-limiting embodiments, the cross-member thickness 410 may be substantially equal to the thickness of the first and second walls 406, 408, thereby providing a uniform structural profile. In other non-limiting embodiments, the cross-member thickness 410 may be greater than the first and second wall thicknesses 406, 408, to enhance strength, stiffness, or load-bearing capacity. Conversely, the cross-member thickness 410 may also be lesser than the first and second wall thicknesses 406, 408, to decrease weight, conserve material, and facilitate flexure. The relative thickness relationship between the cross-member thickness 410 and the first and second wall thicknesses 406, 408 may therefore vary depending on design considerations. For example, a thicker cross-member 130 may be positioned at regions subject to higher stresses, while a thinner cross-member 130 may be used in low-stress regions to optimize efficiency. In some non-limiting embodiments, the cross-member thickness 410 may remain constant along the length of the rail 100, while in other embodiments it may taper or transition along the length of the rail 100. Thereby allowing for localized structural reinforcement or flexibility.

A first slot 424 may be defined at least in part by a top surface 420 of the cross-member 130, an upper-inner surface 412 of the first wall 102, an upper-inner surface 414 of the second side wall 108, and the gap 126 between the first inward protrusion 114 and the third inward protrusion 120. The first slot 424 may be open-ended (i.e., due to gap 126), such that unobstructed insertion or removal of a component along the length 300 of the rail 100 may be permitted. The geometry of the first slot 424 is generally bounded laterally by the first and second side walls 102, 108 and their inward protrusions 114, 120 and vertically by the cross-member 130, so as to create a channel-like region.

The first slot 424 may be configured to receive and retain structural or functional elements, such as a faster, panel edge, or sliding component (discussed below in more detail). In non-limiting embodiments, the first slot 424 dimension may be uniform along the length 300 of the rail 100, while in other embodiments the first slot 424 may vary in width, depth, or cross-sectional profile to suit particular applications. The use of the first and second inward protrusions 116 and 120 to define gap 126 of the first slot 424 provides controlled clearance and retention features, while the open-ended configuration facilities assembly, adjustment, or interchangeability of components.

A second slot 426 may be defined at least in part by a bottom surface 422 of the cross member 130, a lower-inner surface 416 of the first wall 102, a lower-inner surface 418 of the second wall 108, and the gap 128 between the second inward protrusion 118 and the fourth inward protrusion 124. The second slot 426 may be open-ended (i.e., due to gap 128), such that unobstructed insertion or removal a component along the length 300 of the rail 100 may be permitted. The geometry of the second slot 426 is generally bounded laterally by the first and second side walls 102, 108 and their inward protrusions 118, 124 and vertically by the cross-member 130, as to create a channel-like region. Similar to the first slot 424, the second slot 426 may be configured to receive and retain structural or functional elements, such as a faster, panel edge, or sliding component (discussed below in more detail). In non-limiting examples, the second slot 426 dimension may be uniform along the length 300 of the rail, while in other embodiments the second slot 426 may vary in width, depth, or cross-sectional profile to suit particular applications.

In non-limiting embodiments, the first inward protrusion 114 has a thickness 432, the second inward protrusion 118 has a thickness 436, the third inward protrusion 120 has a thickness 434, and the fourth inward protrusion 124 has a thickness 438. The thicknesses 432, 434, 436, and 438 of the protrusions may be uniform along all four inward protrusions 114, 118, 120, and 124, or alternatively, the thicknesses 432, 434, 436, and 438 may differ between each other. For example, the first and third inward protrusions 114, 120 may have a thickness 432, 434 that is different than the thickness 436, 438 of the second and fourth inward protrusions 118, 124.

The thicknesses 432, 434, 436, and 438 of the inward protrusions 114, 118, 120, and 124 may also be defined relative to the thickness of adjacent structural elements, such as the first and second side walls 102, 108 or the cross-member 130. In some non-limiting configurations, the inward protrusions 114, 118, 120, and 124 may be formed with a thickness substantially equal to the first and second wall thicknesses 406, 408 and/or the cross-member thickness 410 to provide a consistent structural profile. In other configurations, the inward protrusion thicknesses 432, 434, 436, and 438 may be thinner than the cross-member thickness 410 and/or the first and second wall thicknesses 406, 408 to conserve material or to facilitate flexibility, or the inward protrusion thicknesses 432, 434, 436, and 438 may be thicker than the cross-member thickness 410 and/or the first and second wall thicknesses 406, 408 to increase strength or retention capability. Accordingly, the inward protrusion thicknesses 432, 434, 436, and 438 may vary both within inward protrusions 114, 118, 120, and 124, and in relation to other components of the system, depending on the desired performance characteristics.

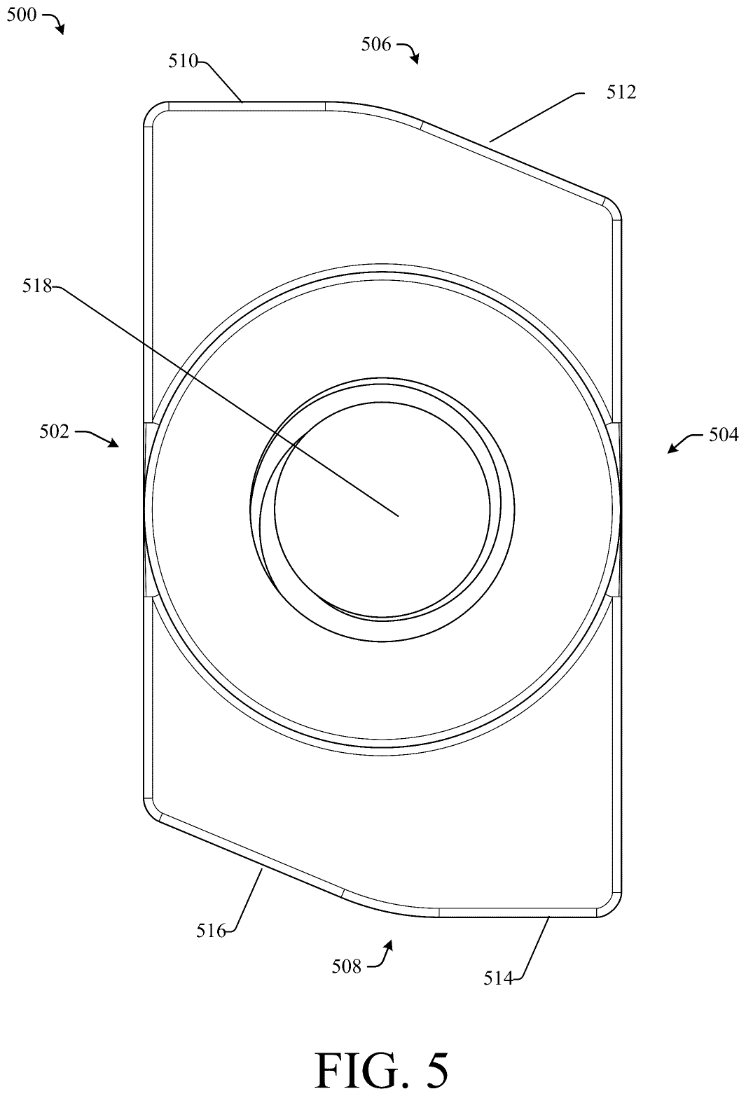

FIG. 5 illustrates a top view of a T-nut 500, according to an embodiment of this disclosure. The T-nut 500 may generally have a rhomboidal shape. The T-nut 500 may define a body with a first side 502, a second side 504 opposite the first side 502, a third side 506, and a fourth side 508 opposite the third side 506. The first side 502 and the second side 504 are generally straight and extend parallel to one other. The third side 506 may include an angled portion 512 and a flat portion 510. The fourth side 508 may include an angled portion 516 and a flat portion 514. The T-nut 500 may also include a threaded aperture 518 that extends though the body of the T-nut 500 to receive a threaded fastener thereby enabling secure attachment of accessories or tie-down components to the rail 100 (discussed in more detail below). The rhomboid shape of the T-nut 500 provides distinct advantages over conventional rectangular or circular T-nut configurations. The rhomboid geometry, characterized by opposite sides being parallel and adjacent sides being of unequal length, creates a stable locking mechanism when rotated within the rail gaps. The angled portions 512 and 516 of the rhomboid shape engage with the interior surfaces of the rail at specific contact points, distributing load forces across multiple surfaces rather than concentrating stress at single points. This geometric arrangement prevents the T-nut 500 from rotating under load while maintaining the ability to be repositioned when desired.

The geometry of the T-nut 500 may permit the T-nut 500 to be orientated for insertion into the rail 100 and then rotated such that the angled portions 512 and 516 engage with the interior surfaces (e.g., 412, 414, 416, and 418) of the slot(s). For example, the specific arrangement and sizing of the angled portions 512 and 516 may vary to alter the degree of engagement with the slot walls. For example, acute and obtuse angular portions may be selected to provide a tight interface fit, rotation lock, or controlled clearance. The combination of the parallel first and second sides 502, 504 and the angled third and fourth sides 506, 508 provides the T-nut 500 with a distinctive rhomboidal configuration that improves retention and stability compared with conventional rectangular or circular T-nuts.

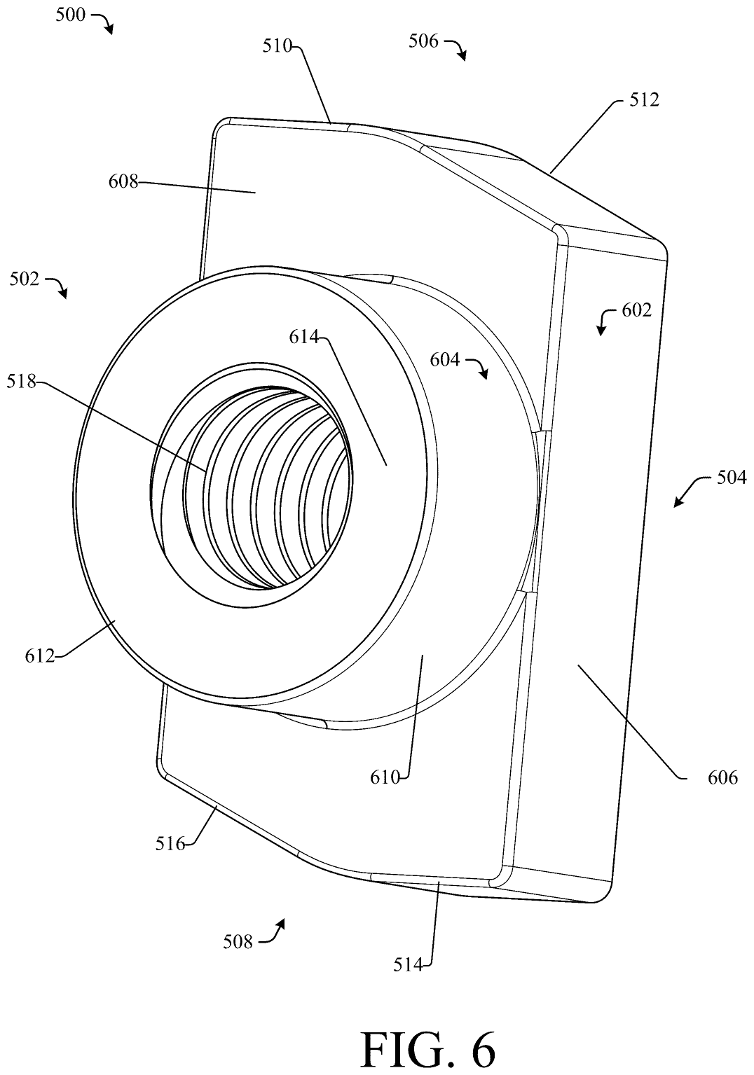

FIG. 6 illustrates a top-side perspective view of a T-nut, according to an embodiment of this disclosure. The T-nut 500 may have a rhomboidal lower portion 602 and a circular upper portion 604. The lower portion 602 may have a thickness 606 and the upper portion 604 may have a thickness 610. In non-limiting embodiment, the lower portion has an upper surface 608 that surrounds the circular upper portion 604. In non-limiting embodiments, the circular upper portion 604 has a radius 614 that extends outwardly such that the arc reaches or substantially intersects with the first side 502 and the second side 504 of the lower portion 602.

The upper portion 604 may have a thickness 610. The upper portion thickness 610 may be substantially similar to a lower portion thickness 606, while in other embodiments, the upper portion thickness 610 may be thicker or thinner than the lower portion thickness 606. In non-limiting embodiments, the upper potion 604 has an upper surface 612 parallel to the lower surface 608.

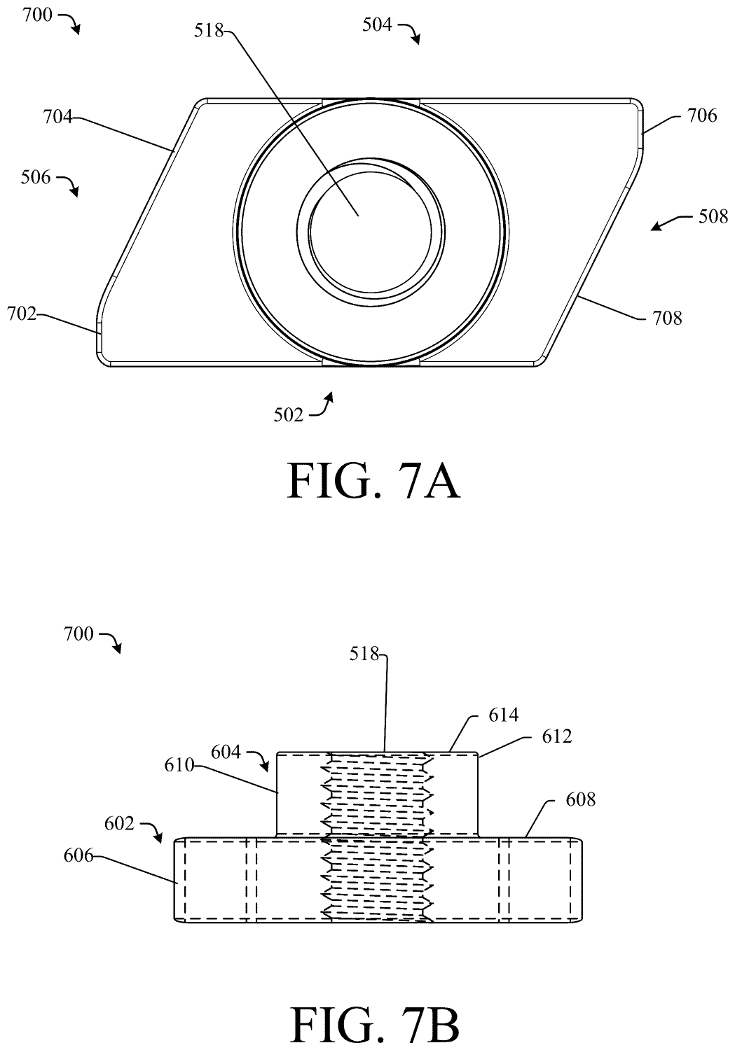

FIGS. 7A-7B depict a top view and side view of a T-nut 700, according to an embodiment of this disclosure. In another non-limiting embodiment, the T-nut 700 may define a body with a first side 502, a second side 504 opposite the first side 502, a third side 506, and a fourth side 508 opposite the third side 506. The first side 502 and the second side 504 are generally straight and extend parallel to one other. The third side 506 and fourth side 508 have angled portions and flat portions similar to those described above, but with altered proportions. In the depicted configuration, the third side 506 may include an angled portion 704 and a flat portion 702 while the fourth side 508 may include an angled portion 708 and a flat portion 706. In this configuration, the angled portions 706 and 708 extend for a greater length, while the flat portions are correspondingly shorter. This variation produces a T-nut 500, 700, 800 that maintains the general rhomboidal profile, but with more (or less) pronounced angled surfaces and reduced flat surfaces.

The increased length of the angled portions 704 and 708 may enhance engagement with the interior surface of the first slot 434, provide a different degree of rotational locking, or alter the distribution of forces applied though the T-nut. Conversely, the shorter flat portions 702 and 706 may reduce contact area along those edges while still processing sufficient planar surfaces for alignment and seating. Such proportional adjustment allows the T-nut 500, 700, 800 geometry to be tailored to specific load, retention, or manufacturing considerations while remaining within the scope of the rhomboidal configuration. The threaded aperture 518 may extend throughout the thickness of the upper and lower portions 604, 602, thereby creating a continuous through-hole in the T-nut 500 configured to receive a threaded fastener.

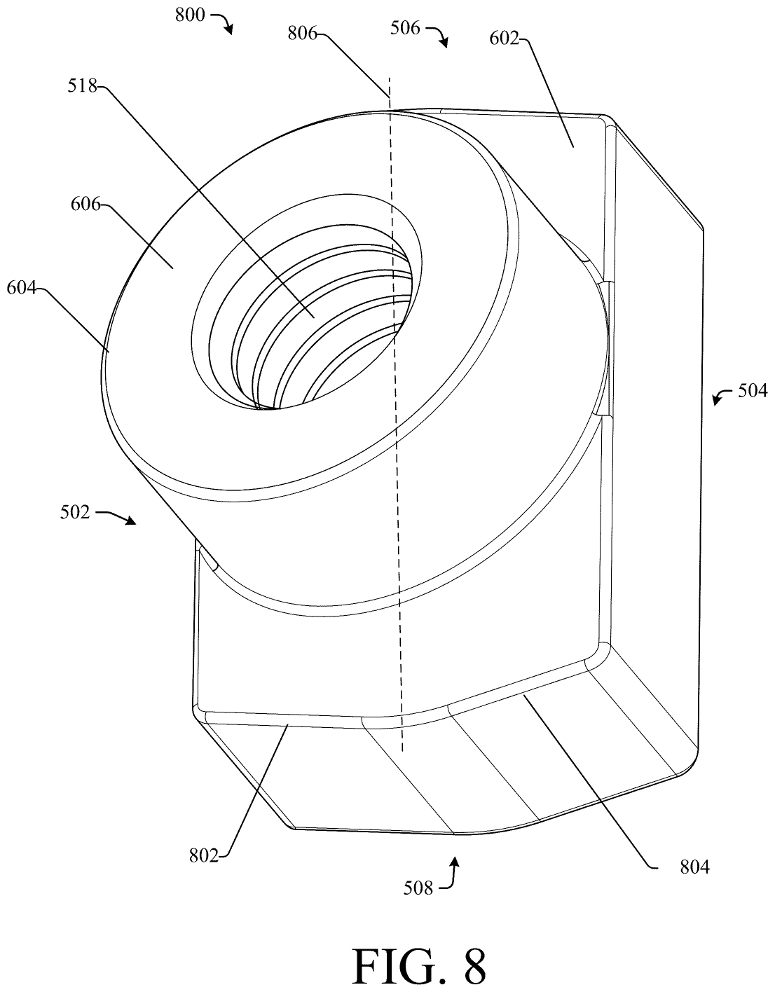

FIG. 8 illustrates a top-side perspective view of a T-nut, according to an embodiment of this disclosure. In another non-limiting embodiment, the T-nut 800 comprises a body with a first side 502, a second side 504 opposite the first side 502, a third side 506, and a fourth side 508 opposite the third side 506. The third side 506 and fourth side 508 may include two angled portions 802 and 804 (as opposed to one angled portion and one flat portion). The first and second sides 502, 504 are generally parallel and may be longer than the third and fourth sides 506, 508, such that the overall profile of the T-nut 800 resembles a rectangular hexagon. In this configuration, the T-nut 800 retains symmetry across its longitudinal axis 806 while presenting a more uniformly faceted perimeter compared to the rhomboidal embodiment with mixed angled and flat portions, such as those depicted in FIGS. 5-7B.

The hexagonal-like profile may provide balanced engagement with the interior surfaces of the first slot 424, reduce stress concentrations, and facilitate controlled rotation during installation. The absence of flat portions allows the angled portions 802, 804 to directly define the engagement geometry, thereby offering a more continuous distribution of contact forces. This non-limiting configuration may be advantageous in applications requiring enhanced load distribution, rotational resistance, or simplified manufacturing of the T-nut 800.

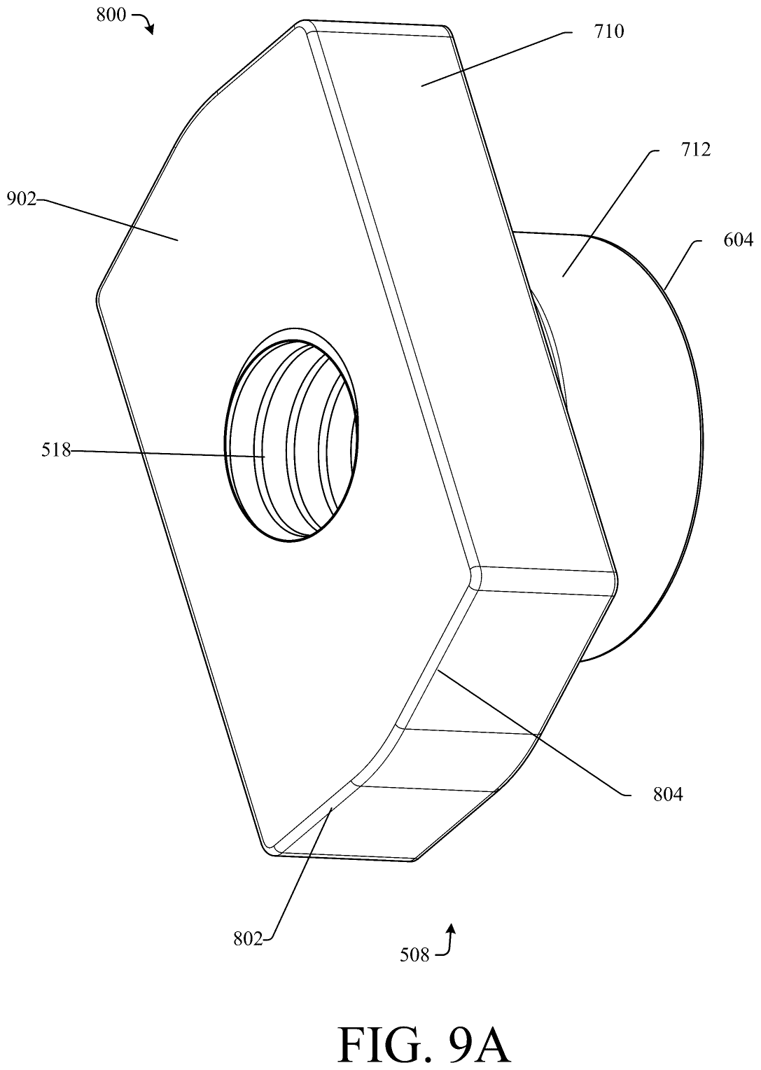

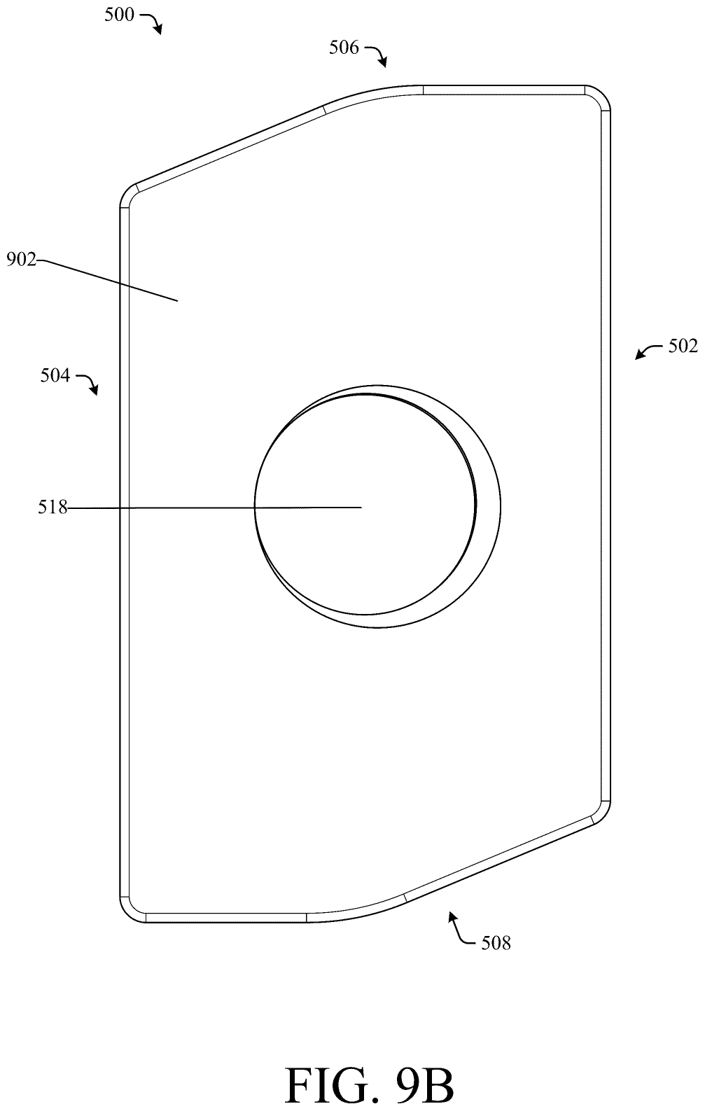

FIGS. 9A-9B illustrates a bottom-side perspective view of a T-nut, according to an embodiment of this disclosure. In non-limiting embodiments, The T-nut 500, 700, 800 may include a bottom surface 902 configured to lie substantially flush against the interior surfaces of the first slot 424 in which it may be received. The bottom surface 902 may be planar and extend across the entirety of the T-nut 500, 700, 800 such that, when seated properly, the bottom surface 902 conforms closely to the top surface 420 of the cross-member 130.

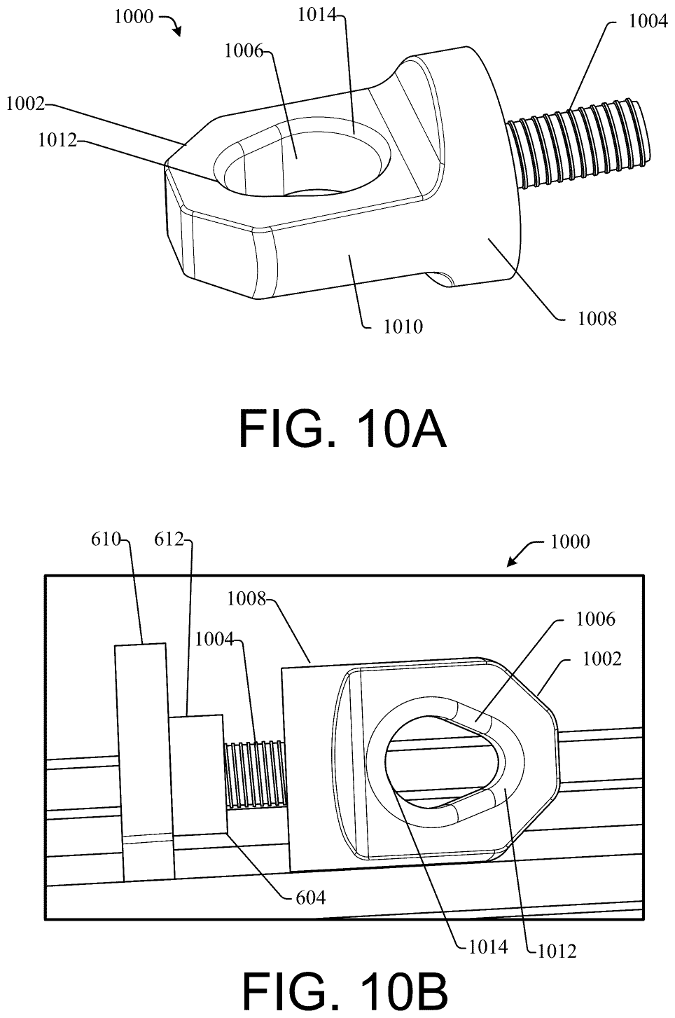

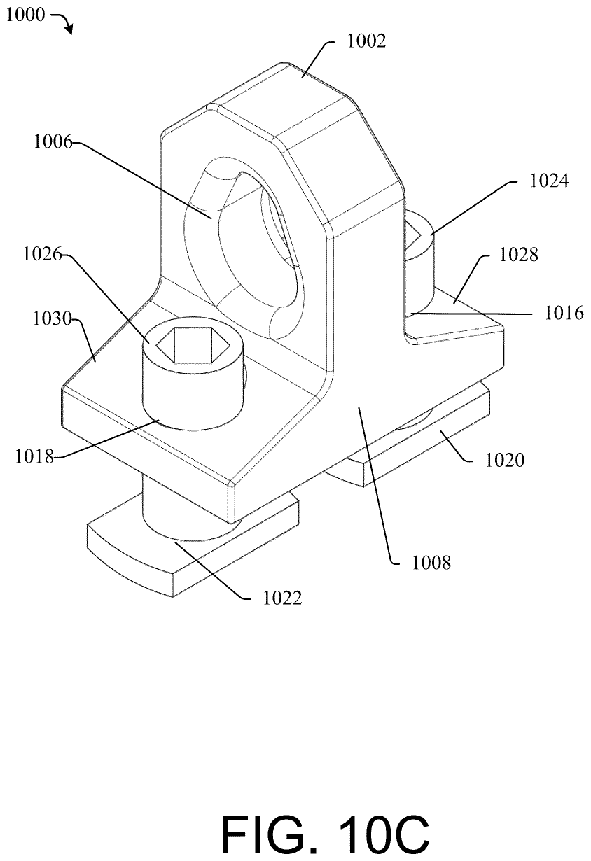

FIGS. 10A-10C depict a tie-down 1000 in an assembled and un-assembled configuration, according to an embodiment of this disclosure. The tie-down 1000 may include an upper portion 1002 and a threaded fastener 1004 dimensioned to engage with the internal threads of the threaded aperture 518 of the T-nut 500, 700, 800 in a secure, mating relationship. The integral threaded fastener 1004 of the tie-down connector 1000 may be permanently attached to the upper portion 1002 through various manufacturing methods. In some embodiments, the threaded fastener 1004 may be machined as a single piece with the upper portion 1002, creating a monolithic structure that eliminates potential failure points associated with separate fastener attachment. In other embodiments, the threaded fastener 1004 may be welded, brazed, or otherwise permanently joined to the upper portion 1002 during manufacturing. The integral design ensures that the fastener 1004 cannot be lost or separated from the tie-down connector 1000 during use. In other non-limiting embodiments, the threaded fastener 1004 may be removably secured to the upper portion 1002 using a torque and threaded locking mechanism. The upper portion 1002 of the tie-down may be formed from a variety of materials suitable for providing strength and durability. Non-limiting examples include metals such as steel, stainless steel, brass, or aluminum alloys, which may be selected for their load-bearing capacity and resistance to wear. In other embodiments, the T-nut may be formed from engineered polymers or plastics, such as reinforced nylon, acetal, or high-performance composites, to reduce weight and resist corrosion. The selection of the material for the upper portion 1002 may be based on factors such as intended load, environmental exposure, cost, and east of manufacture.

The upper portion 1002 of the tie-down 1000 may define an opening 1006 configured to receive a rope, strap, hook, or other securing element. The opening 1006 may have a generally ovoid shape defined by a first curved end 1014 and a second curved end 1012. In non-limiting embodiments, the first curved end 1014 may have a greater radius than the second curved end, thereby creating an asymmetric ovoid geometry. This configuration provides a larger bearing surface at the first end for distributing load, while the smaller radius at the second end facilitates retention and preferential alignment of the secured element. The generally ovoid shape of the tie-down connector opening 1006 provides optimized load distribution characteristics compared to circular or rectangular openings. The ovoid geometry, defined by the combination of curved ends 1012, 1014 with different radii, creates a shape that naturally accommodates various tie-down hardware configurations while minimizing stress concentrations. The larger radius at the first curved end 1014 provides increased bearing surface area for distributing loads from straps, ropes, or hooks, while the smaller radius at the second curved end 1012 facilitates secure retention of tie-down hardware and prevents inadvertent disengagement during use.

The upper portion 1002 of the tie-down 1000 may include a flared base 1008 and a narrow body 1010. The flared base 1008 may extend outwardly relative to the narrow body 1010, providing an enlarged footprint or bearing surface for stability and load distribution. The narrow body 1010 extends upward from the flared based with a reduced cross-sectional dimension, thereby creating a necked or tapered profile. In some non-limiting embodiments, the transition between the flared base 1008 and the narrow body 1010 may be gradual, defined by a curved or slope surface, whereas in other implementations the transition may be abrupt, defined by a shoulder or step. The relative proportions of the flared base 1008 and narrow body 1010 may vary depending on the desired load-bearing capacity, aesthetic design, or manufacturing considerations.

FIG. 10C illustrates a tie-down 1000 configured to engage with two exemplary T-nuts 500, 700, 800. In a non-limiting embodiment, the flared base 1008 may include a first through hole 1016 disposed on a first side 1028 and a second through hole 1018 disposed on a second side 1030, wherein the first and second through holes 1016, 1018 are sized to accept the threaded fastener 1004 of a first T-nut 1020 and the second T-nut 1022, respectively. The first and second T-nuts 1020, 1022 may be secured to the flared base 1008 by way of a first nut 1024 and a second nut 1026, respectively. The first and second nuts 1024, 1026 may have a complementary shape and size relative to the threaded fastener 1004, thereby maintaining secure engagement of the first and second T-nuts 1020, 1022, through the flared base 1008 of the tie-down 1000. The flared geometry of the upper portion 1002 may provide increased stability and surface area for distributing forces applied to the tie-down 1000 during use. The first and second through holes 1016, 1018 allow the tie-down 1000 to accommodate multiple exemplary T-nuts 500, 700, 800, enabling robust attachment to the rail 100.

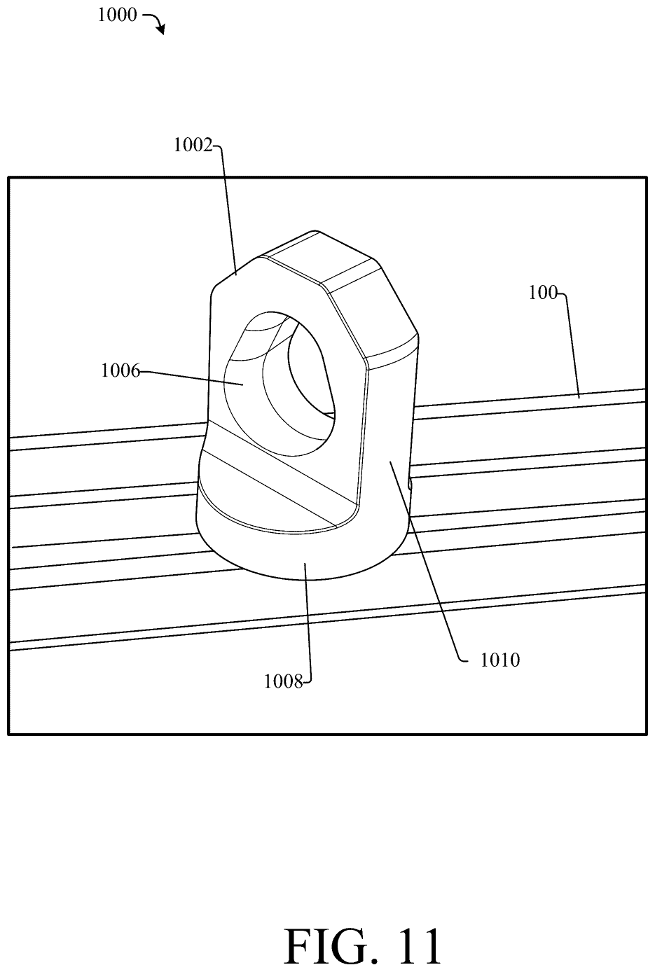

FIG. 11 illustrates a tie-down assembled in an extruded rail. In certain embodiments, the tie-down 1000 is drawn toward the rail 100 thereby clamping the rail 100 between the tie-down 1000 and the engaged T-nut 500, 700, 800. The rhomboidal geometry of T-nut 500, 700, 800 enhances the locking mechanism by creating interference or frictional contact against the interior surfaces of the rail 100, reducing the likelihood of loosing or rotation under load. The result is a secure and adjustable attachment point for straps, ropes, or other cargo-retention elements.

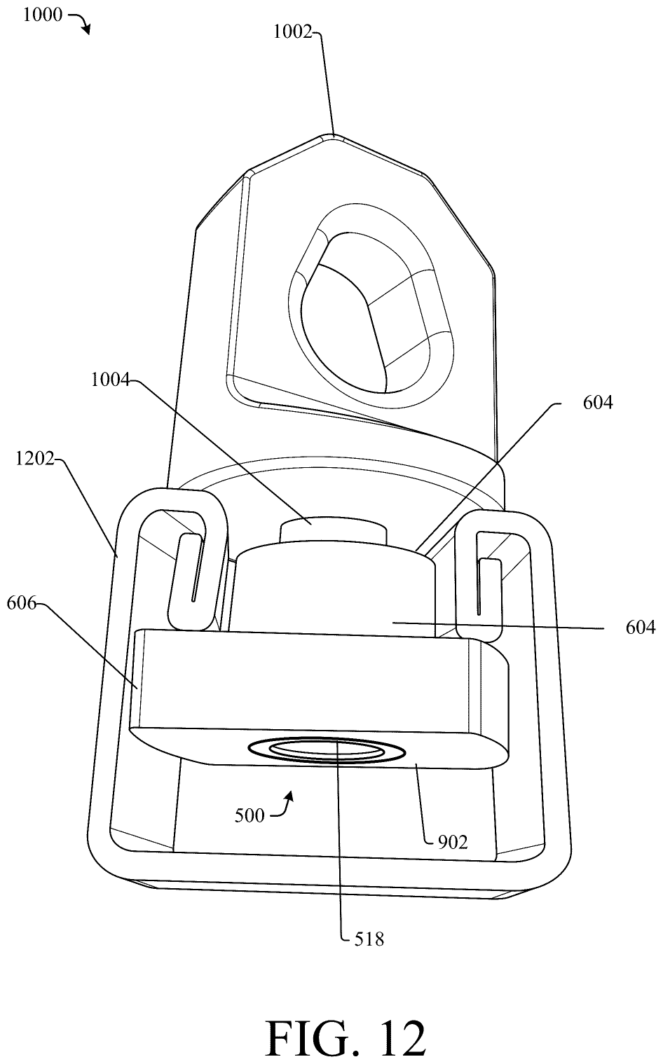

FIG. 12 illustrates a front perspective view of a tie-down assembled with the T-nut in an extruded rail, according to an embodiment of this disclosure. The tie-down 1000 is shown in an assembled configuration. In an assembled configuration, the T-nut 500, 700, 800 may be inserted into an exemplary rail 1202 in an unsecured position and subsequently be rotated to a secured position, wherein the rhomboidal shape of the T-nut causes angled portions (e.g., 512, 516, 704, 708, 802, 804) of the T-nut 500, 700, 800 to engage complementary interior surfaces (e.g., 412, 414, 416, 418, 420, 422) of the rail. The engagement resists withdrawal of the T-nut 500, 700, 800 from the first slot 424 of the rail 100 and provides a secure seating arrangement. A threaded fastener 1004 extending from the tie-down 1000 may be received within the threaded aperture 518 of the T-nut 500, 700, 800. As the threaded fastener 1004 is tightened, the tie-down 1000 is drawn toward the rail 100, thereby clamping the rail 100 between the tie-down 1000 and engaged T-nut 500, 700, 800.

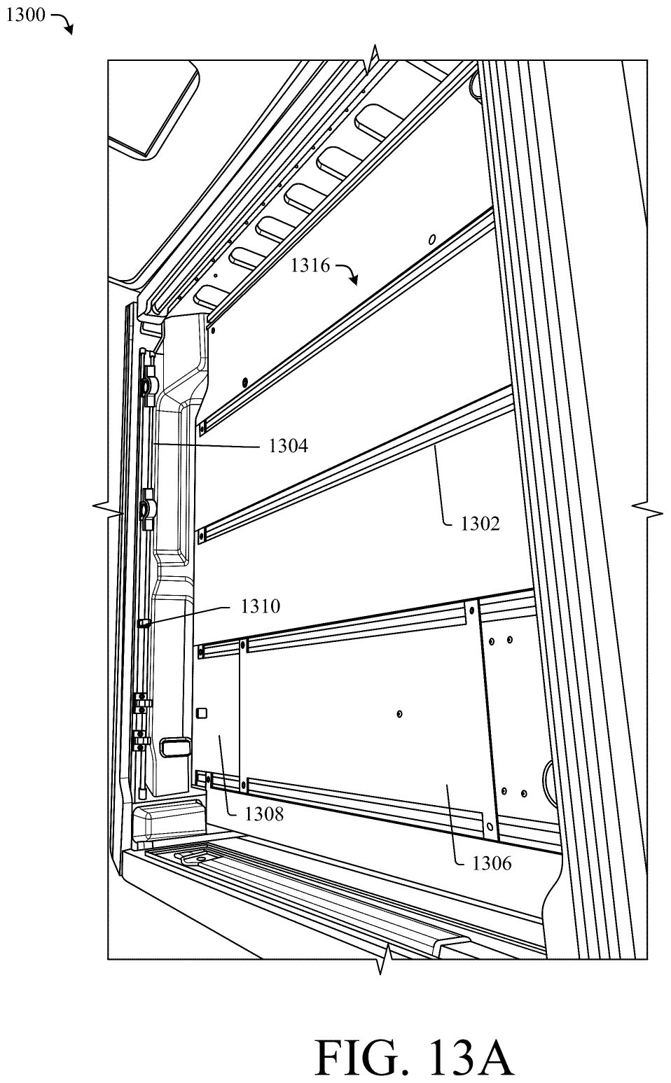

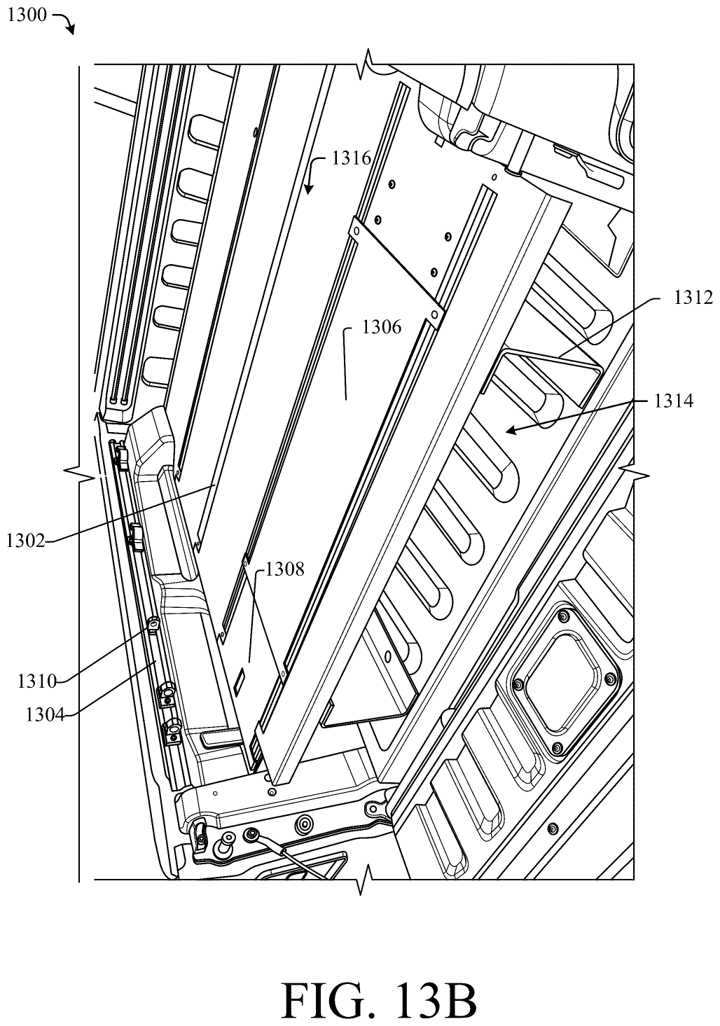

FIGS. 13A-13B depict the truck bed storage system and components assembled within a truck, according to an embodiment of this disclosure. In non-limiting embodiments, the assembled truck bed storage system 1300 may include one or more floor rails 1302 and one or more side rails 1304. Additionally, one or more interconnected panels 1306 may be removably secured to the one or more floor rails 1302, forming a modular panel system 1316. This modular configuration may allow for rapid installation, removal, or reconfiguring depending on cargo needs. The modular platform configuration of the panel system 1316 enables users to customize the storage arrangement according to specific cargo requirements. In some embodiments, the plurality of interconnected panels 1306 may be arranged to create a continuous platform spanning substantially the entire truck bed area. In other embodiments, the panels 1306 may be configured to create partial platforms with designated open areas for accommodating oversized cargo items. The removable securing mechanism allows individual panels 1306 to be quickly detached and repositioned or removed entirely when full bed access is required. An access door 1308 may also be incorporated into the panel system 1316. The access door 1308 may be hingedly or slidably mounted to the one or more floor rails 1302 to provide access to storage areas defined beneath the panel system 1316. The tie-down and T-nut connector assembly 1310 may be used to secure various items to the one or more side rails 1304 or the one or more floor rails 1302. The connector assembly 1310 may interface with a rail 100 or a series of rails to provide an attachment point for accessories, cargo, or additional tie-down elements. The connector assembly 1310, in other non-limiting embodiments, may be configured for exclusive use with the floor rail 1302 or the side rail 1304. Conversely, the connector assembly 1310 may be interchangeably used with either the floor rail 1302 or the side rail 1304, or both, thereby providing flexibility in positioning and securing items within the storage system 1300.

In a non-limiting embodiment, the panel system 1316 is raised above the truck bed and supported by one or more supports 1312 disposed beneath the one or more panels 1306. The raised panel system 1316 defines a cavity or series of cavities 1314 between the underside of the panel system 1316 and the truck bed floor. The cavity may function as a secure and concealed storage space for tools, equipment, or other items accessible through the access door. In some non-limiting embodiments, the cavities 1314 may extend substantially across the bed of the truck to maximize storage volume, while in others it may be localized to create both open and enclosed storage areas with the truck bed. The one or more interconnected panels 1306, access door 1308 and supports 1312 may be formed from a variety of material suited to proper strength, durability, and environmental exposure. For example, the one or more panels 1306 and access door 1308 may be fabricated from metals such as aluminum alloys or steel for structure rigidity, or from engineered polymers and composites such as reinforced plastics, fiberglass, or carbon fiber to reduce weight and resist corrosion. The supports 1312 may likewise be formed from metals, composites, or other high-strength polymers, with material selection based on the desired load-bearing capacity and overall system weight.

In non-limiting embodiments, the one or more support panels 1306 are configured to rest on top of the first and second outward protrusions 116, 122 of the rail 100. As discussed above, the first and second outward protrusions 116, 122 may extend outward from the first and second side walls 102, 108 at a position below the first and second top ends 104 and 110 of the first and second side walls 102, 108, thereby defining edges 206 and 208 between the upper surfaces 202, 204 of the first and second outward protrusions 116, 122 and the first and second top ends 104, 110 of the first and second side walls 102, 108. The one or more support panels 1306 may be seated on the upper surfaces 202, 204 of the first and second outward protrusions 116, 122 such that the exposed top surface of each one or more support panels 1306 lies substantially flush with the first and second top ends 104, 110 of the first and second side walls 102, 108. This configuration provides a continuous load-bearing platform across the rail 100 and support panels 1306, enabling cargo or other items to slide across the surface without interference from the rail structure. By resting on the recessed protrusions, the support panels 1306 are securely supported while preserving a smooth, uninterrupted surface at the top of the system 1300. The edges 206 and 208 created by the offset between the first and second outward protrusions 116, 122 and the first and second top ends 104, 110 of the first and second side walls 102, 108 therefore facilitate both stable seating the one or more support panels 1306 and a flush interface for cargo handling.

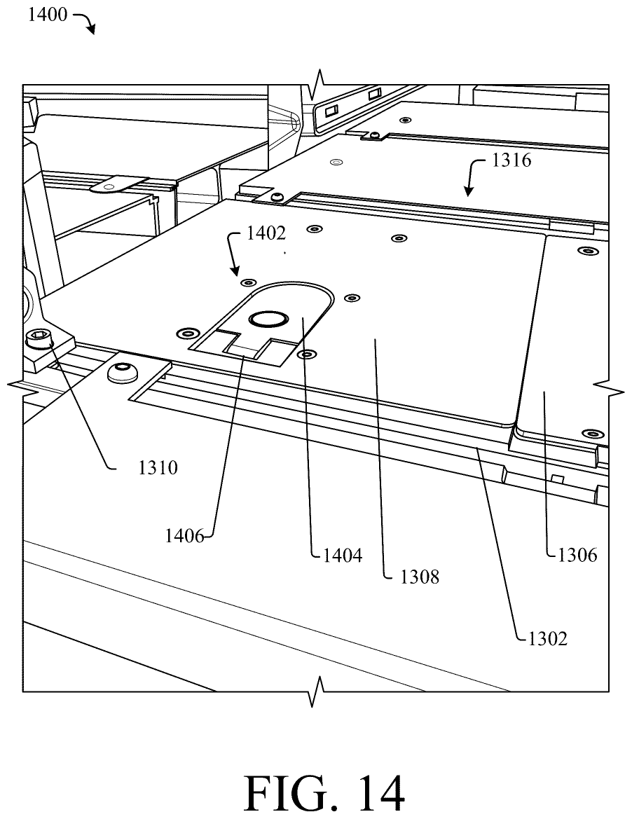

FIG. 14 illustrates a closed access door 1308 within the truck bed storage system 1400, according to an embodiment of this disclosure. In non-limiting embodiments, the access door 1308 is hingedly connected to the panel system 3116, allowing the access door 1308 to pivot between an open position and a closed position. A locking mechanism 1402 may be provided to secure the access door 1308 is a closed position. The locking mechanism 1402 may engage with a latch mechanism integrated into the adjacent portion of the panel system 1316 to prevent unintended opening. The latch mechanism integrated into the panel system 1316 may comprise various configurations depending on the specific requirements of the access door 1308 installation. In some embodiments, the latch mechanism may include a spring-loaded catch that automatically engages when the access door 1308 is closed. In other embodiments, the latch mechanism may comprise a mechanical striker plate or hook arrangement that receives the latch element from the rotatable handle. The integration of the latch mechanism into the panel system 1316 structure provides a secure mounting point that distributes closing forces across the panel framework rather than concentrating stress at isolated attachment points.

In one example, the locking mechanism 1402 includes a rotatable handle 1404 operatively connected to a latch element 1406, such that rotation of the handle 1404 causes the latch element 1406 to engage or disengage with the latch mechanism. In other non-limiting embodiments, alternative locking arrangements may be employed, such as sliding latches, spring-biased locks, cam locks, keyed locks, electronic locks, or other known locking mechanism. These variations allow the access door to be secure in a manner best suited for the intended application, balancing convenience, security, and durability.

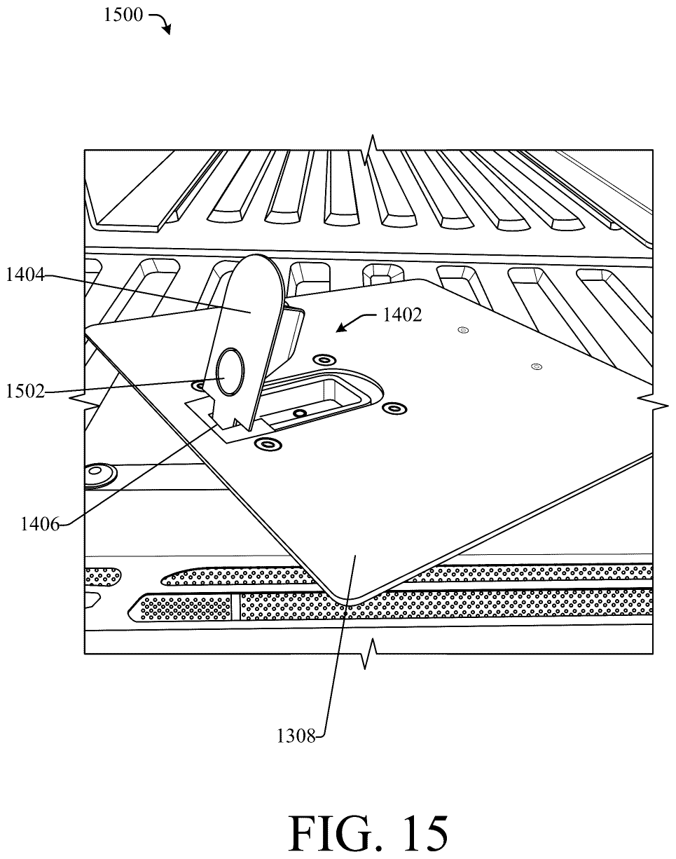

FIG. 15 illustrates a removed access door 1308 within the truck be storage system 1500, according to an embodiment of this disclosure. In a non-limiting embodiment, the locking mechanism 1402 may include a button 1502 or other actuator configure to initiate engagement or disengagement of the mechanism. Actuation of the button 1502, or equivalent trigger, may release the lock from the catch mechanism or drive the lock into engagement, thereby facilitating the removal or securement of the access door 1308.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. An extruded rail for a truck bed storage system, comprising:
a first side wall having a top end and a bottom end; and
a second side wall having a top end and a bottom end, the second side wall being spaced apart from the first side wall;
wherein the first side wall comprises:
a first inward protrusion at the top end extending toward the second side wall and a first outward protrusion extending from the second side wall; and
a second inward protrusion at the bottom end extending toward the second side wall;
wherein the second side wall comprises:
a third inward protrusion at the top end extending toward the first side wall and a second outward protrusion extending from the first side wall, wherein a first gap is defined between the first inward protrusion and the third inward protrusion; and
a fourth inward protrusion at the bottom end extending toward the first side wall, wherein a second gap is defined between the second inward protrusion and the fourth inward protrusion; and
a cross-member extending from a first position on the first side wall to a second position on the second side wall, wherein the first position is disposed between the top end and the bottom end of the first side wall and the second position is disposed between the top end and the bottom end of the second side wall.

2. The extruded rail of claim 1, wherein the extruded rail comprises a hard aluminum alloy.

3. The extruded rail of claim 2, wherein the hard aluminum alloy is selected from a group consisting of 6061-T6 aluminum and 7075-T6 aluminum.

4. The extruded rail of claim 1, wherein the first gap has a first distance and the second gap has a second distance that is substantially similar to the first distance.

5. The extruded rail of claim 1, wherein the first gap has a first distance and the second gap has a second distance different from the first distance.

6. The extruded rail of claim 1, wherein the first outward protrusion and the second outward protrusion have a first thickness and the first inward protrusion and the third inward protrusion have a second thickness, wherein the first thickness is less than the second thickness.

7. The extruded rail of claim 1, wherein the cross-member has a third thickness, the third thickness being less than a second thickness of the first and third inward protrusions.

8. The extruded rail of claim 1, wherein the first outward protrusion and the second outward protrusion are configured to contact a surface of an existing rail system to position the extruded rail flush with the surface.

9. The extruded rail of claim 1, wherein the first inward protrusion and the third inward protrusion maintain a top edge flush with a sheet of material forming a wall or floor to enable items to slide across without catching on the extruded rail.

10. A truck bed storage system, comprising:
an extruded rail having a first side wall, a second side wall spaced apart from the first side wall, and a cross-member extending between the first and second side walls, wherein the first and second side walls each include inward protrusions that define gaps therebetween;
a T-nut having a rhomboid shape with a first side including a first angled portion and a second straight portion, a second side including a third straight portion and a fourth angled portion, and a threaded aperture extending through the T-nut, wherein the T-nut is sized to fit within the gaps and rotate to a locked position where the first angled portion and fourth angled portion contact interior surfaces of the extruded rail; and
a tie-down connector having an integral threaded fastener configured to engage the threaded aperture of the T-nut.

11. The truck bed storage system of claim 10, wherein the T-nut includes a shouldered portion extending from a top surface of the T-nut.

12. The truck bed storage system of claim 10, wherein the T-nut is configured to be inserted into the gaps in a first orientation where a length of the T-nut is substantially parallel with a length of the extruded rail, and rotated to the locked position where the first angled portion and fourth angled portion prevent further rotation.

13. The truck bed storage system of claim 12, wherein a length of the T-nut is greater than a width across the gaps such that the T-nut cannot fully rotate within the gaps in either direction when in the locked position.

14. The truck bed storage system of claim 10, wherein rotation of the integral threaded fastener into the threaded aperture causes the T-nut to rotate within the extruded rail until the first angled portion and fourth angled portion contact the interior surfaces to prevent additional rotation, allowing the tie-down connector to be tightened without requiring additional tools to secure the T-nut.

15. The truck bed storage system of claim 10, wherein the tie-down connector has an opening having a generally ovoid shape defined by a first curved end and a second curved end, the first curved end having a greater radius than then second curved end.

16. A truck bed storage system, comprising:
an extruded rail having first and second side walls with inward protrusions defining gaps, and a cross-member extending between the side walls;
a T-nut having a rhomboid shape with angled portions configured to lock within the gaps of the extruded rail and a threaded aperture;
a tie-down connector having a threaded fastener configured to engage the T-nut;
an access door configured to provide access to cargo stored within the truck bed; and
a panel system configured to interface with the extruded rail to form a platform in a bed of a truck.

17. The truck bed storage system of claim 16, wherein the access door is hingedly connected to the panel system and includes a locking mechanism to secure the access door in a closed position.

18. The truck bed storage system of claim 17, wherein the locking mechanism comprises a rotatable handle that engages with a latch mechanism integrated into the panel system.

19. The truck bed storage system of claim 16, wherein the panel system comprises a plurality of interconnected panels that are removably secured to the extruded rail to form a modular platform configuration.

20. The truck bed storage system of claim 16, wherein the extruded rail is one of a side rail or a floor rail.
